(19) United States
(12) Patent Application Publication
(10) Pub. No.: US 2015/0275555 A1
(43) Pub. Date: Oct. 1, 2015

(54) CASEMENT WINDOW WITH SINGLE POINT LOCK MECHANISM

(71) Applicant: HWD Acquisition, Inc., Medford, WI (US)

(72) Inventor: SCOTT D. ALBRECHT, Merrill, WI (US)

(21) Appl. No.: 14/242,452

(22) Filed: Apr. 1, 2014

(51) Int. Cl. E05C 3/04; E06B 3/36

(52) U.S. Cl. CPC E05C 3/041; E06B 3/36

(57) ABSTRACT

A window assembly is disclosed that includes a base frame assembly including a plurality of base frame members and a plurality of frame cladding members connected to the base frame members. A sash assembly is also provided that includes a plurality of sash frame members. A lock assembly is provided that includes a lock keeper mounted to one of the cladding members and includes a lock handle and pawl operably mounted to one of the sash frame members. The lock handle and lock pawl are rotatable between a locked position and an unlocked position.

### TECHNICAL FIELD

This disclosure relates generally to window assemblies, and methods of constructing window assemblies.

### BACKGROUND

Window assemblies have historically been fabricated with a structural base frame, a sash frame that holds one or more glass panes, and various trim pieces. The base frame is the portion of the window assembly which is attached to the structure of the building. The sash frame is the portion of the window assembly which holds the window pane and fits within the base frame. In casement window assemblies, the sash frame is rotatably mounted to the base frame such that the sash frame can be rotated between an open position and a closed position. It is often desirable to provide a locking mechanism on the window assembly such that the sash frame can be secured in the closed position. However, many such locking mechanisms require extensive millwork in the base frame and sash frame. Also, many known locking mechanisms have specially fabricated parts that are not necessarily usable in locking mechanisms for other types of windows. Improvements are desired.

### SUMMARY

A casement window assembly having a single point lock mechanism is disclosed. In one aspect, the window assembly includes a base frame assembly and a sash assembly. The base frame may include a plurality of base frame members and a plurality of base frame cladding members connected to the base frame members. The sash assembly is configured to retain a glass pain and is rotatably mounted to the base frame assembly such that the sash assembly can rotate between an open and a closed position. In one embodiment, the sash assembly includes a plurality of sash members and a plurality of sash cladding members attached to the sash members, wherein the sash members have a first side, a second side, a third side, and a fourth side. One of the sash members may be provided with a bore extending from the sash member first side to a bore end. The sash member may also be provided with a slot extending from the sash member second side to a slot end wherein the bore meets the slot near the bore end and the slot end.

The casement window assembly is also disclosed as including a lock assembly. In one aspect, the lock assembly includes a lock keeper having a base portion and a latch portion, wherein the base portion is mounted to one of the base frame cladding members, for example by a fastener. A lock pin may also be provided that has a first end and a second end, wherein the lock pin extends through the bore and is non-rotatably attached at the first end to a lock handle. The lock assembly may also include a lock pawl having a first end and a second end, wherein the lock pawl extends within the slot and wherein the lock pawl first end is non-rotatably attached to the lock pin second end such that rotation of the lock handle causes the lock pawl to rotate about the same rotational axis.

In operation, the lock pawl is rotatable from a locked position to an unlocked position via the lock handle. In the locked position, the lock pawl is rotated by the lock handle and lock pin such that the lock pawl second end engages with the latch portion of the lock keeper to prevent the sash assembly from being able to rotate out of the closed position. In the unlocked position, the lock pawl is rotated by the lock handle and lock pin such that the lock pawl second end disengages with the latch portion of the lock keeper to allow the sash assembly to rotate out of the closed position and towards the open position.

### DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a perspective view of a window assembly including a lock assembly having features that are examples of aspects in accordance with the principles of the present disclosure.

FIG. 1A is a schematic perspective view of a window assembly having shared features with that shown in FIG. 1 and including the lock assembly of FIG. 1.

FIG. 2 is a cross-sectional side view of the window and lock assembly of FIGS. 1 and 1A with the window assembly in a closed position.

FIG. 3 is a top view of a base frame member of the window assembly of FIGS. 1 and 1A.

FIG. 4 is a side view of the base frame member of FIG. 3.

FIG. 5 is a cross-sectional view of the base frame member of FIG. 3, taken along the line 5-5.

FIG. 6 is a side view of a handle assembly shown in the window and lock assembly of FIG. 1.

FIG. 7 is a top view of the handle assembly of FIG. 6.

FIG. 8 is an end view of the handle assembly of FIG. 6.

FIG. 9 is a side view of a lock pawl shown in the window and lock assembly of FIG. 1.

FIG. 10 is an end view of the lock pawl of FIG. 9.

FIG. 11 is a top view of the lock pawl of FIG. 10.

FIG. 12 is a front view of a lock keeper shown in the window and lock assembly of FIG. 1.

FIG. 13 is a side view of the lock keeper of FIG. 12.

FIG. 14 is a perspective view of a portion of the window and lock assembly of FIG. 1, with the lock assembly placed in a locked position.

FIG. 15 is a perspective view of a portion of the window and lock assembly of FIG. 1, with the lock assembly placed in an unlocked position.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

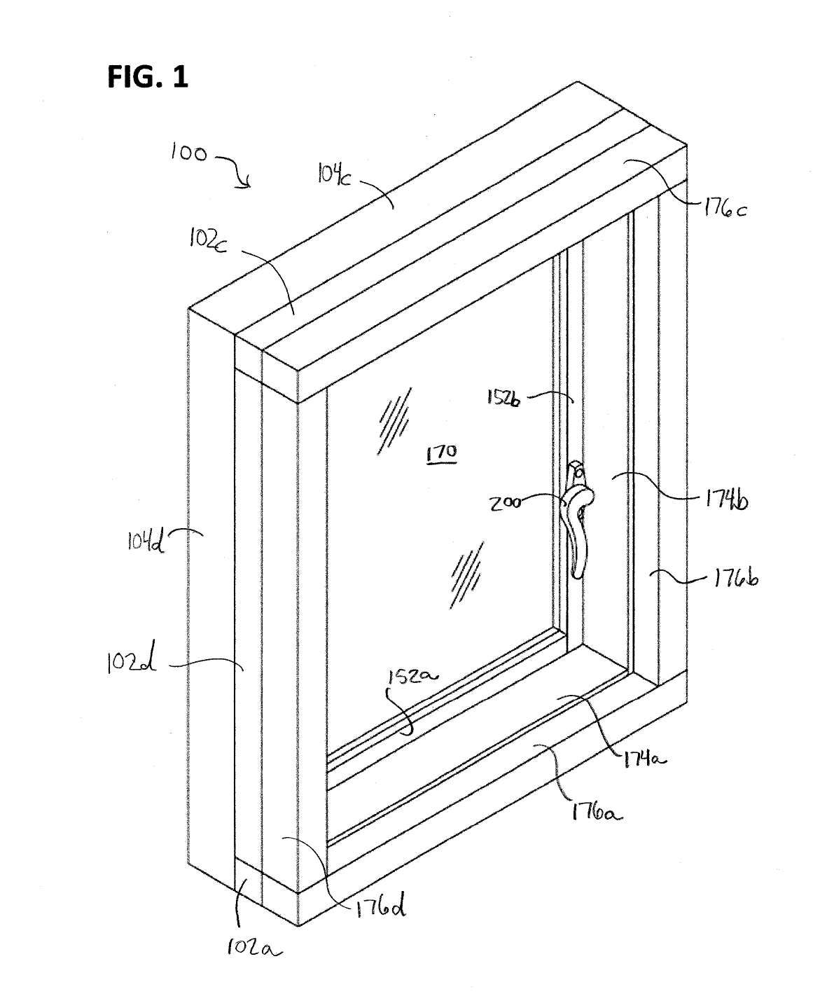

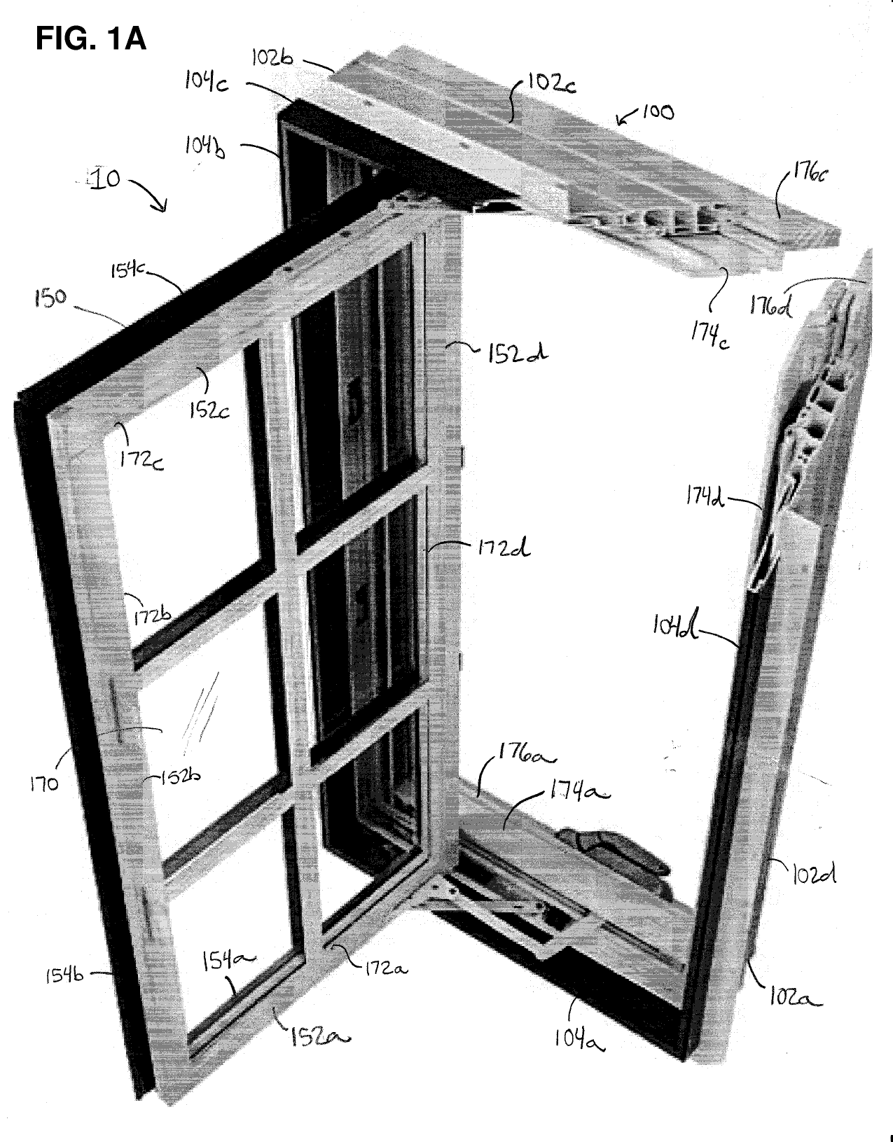

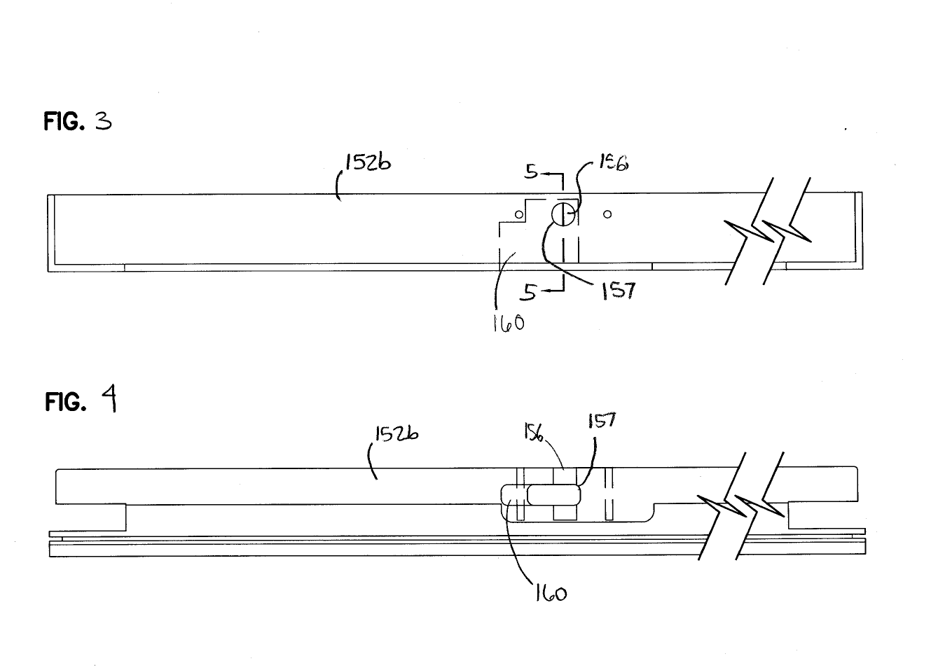

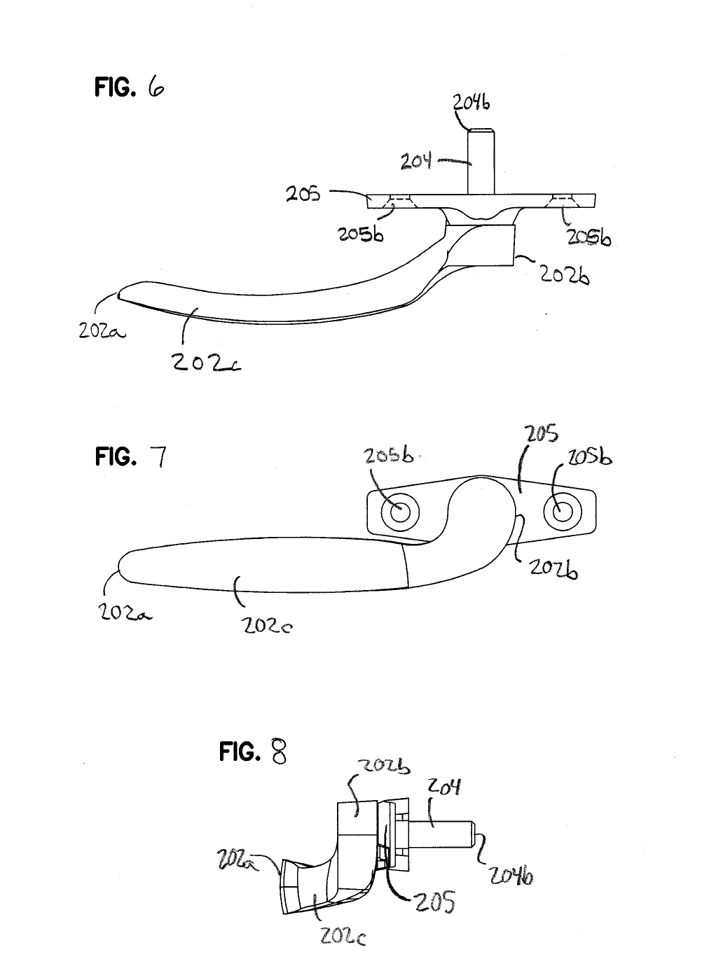

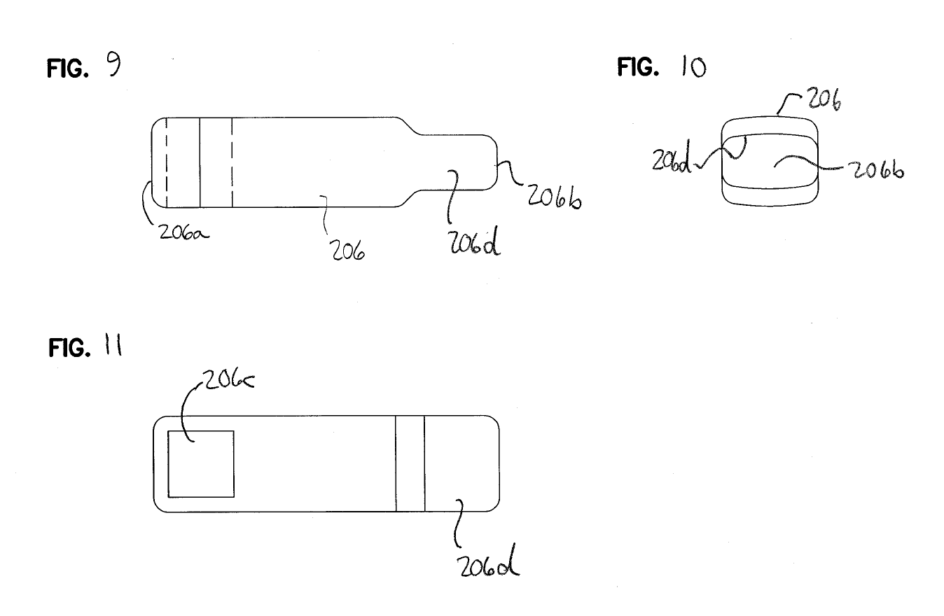

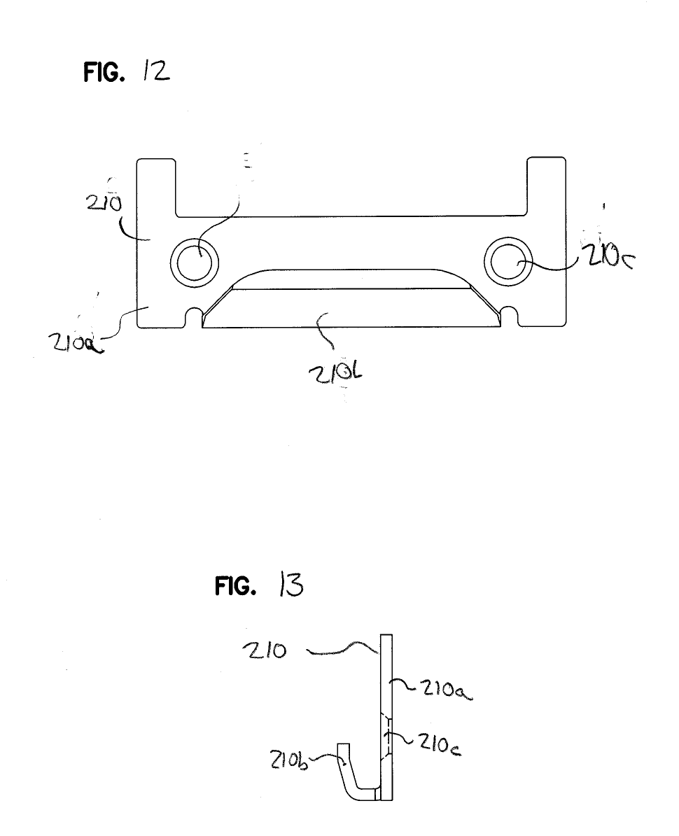

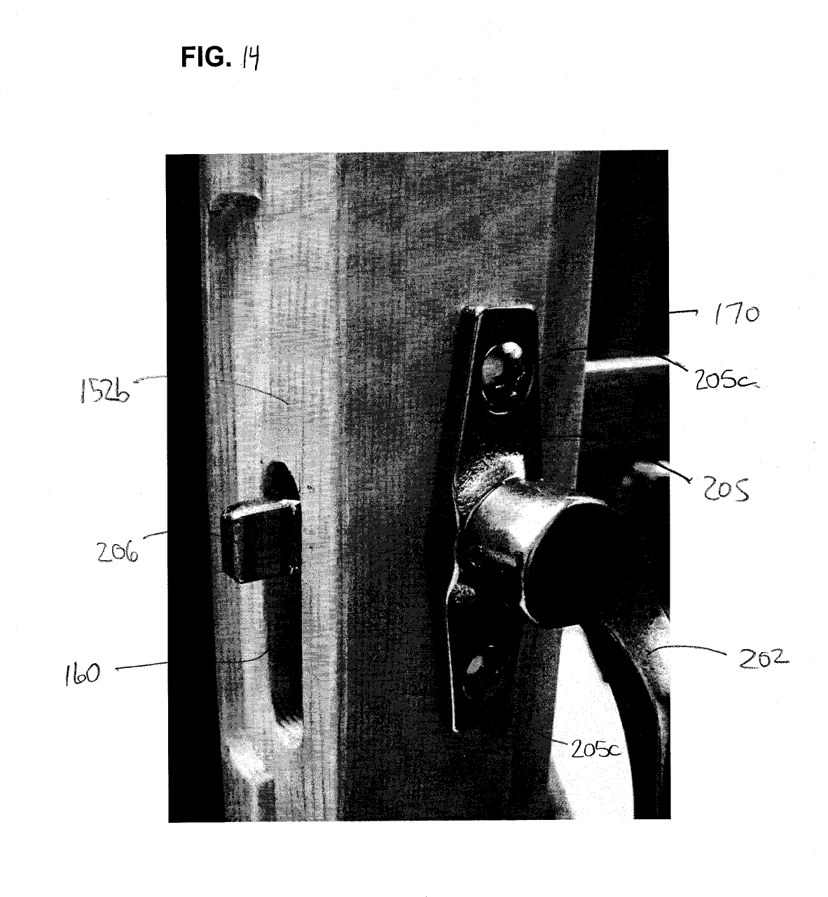

In the embodiment illustrated in FIGS. 1-15, window assembly 10 having a base frame assembly 100, a sash frame assembly 150, and a lock assembly 200 is shown, as explained in detail below.

One aspect of the disclosure is base frame assembly 100. Base frame assembly 100 is the portion of window assembly 10 that is directly connected to the wall surrounding the opening of a building or other structure. The base frame assembly 100 provides the primary structural support for window assembly 10 and additionally provides a platform to which the other components of window assembly 10 can be mounted. As shown in FIGS. 1 and 1A, base frame assembly 100 defines a frame having the shape of a rectangle or square from four base frame members, 102a, 102b, 102c, 102d (102a-102d). Other shapes are possible. Each of the four base frame members 102a-102d may be cut from a common base frame member stock such that they all have the same cross-sectional profile. Further, base frame member stock segments can be produced in lineal fashion such that many base frame members can be cut from a single length of stock. Thus, the use a single lineal profile for all of the base frame members 102a-102d results in a reduction of frame part types, part machining and assembly time. The base frame members 102a-102d may be constructed from many materials, such as wood and extrudeable, pultrudeable or roll formed materials, including but not limited to aluminum, steel alloys, polyolefin polymers, cellular PVC (polyvinyl chloride or vinyl) polymers, cellulosic plastic composites, fiberglass composites, polymeric alloys or other extrudeable, pultrudeable and formable material.

The base frame assembly 100 may also include a plurality of corresponding cladding members 104a, 104b, 104c, 104d (104a-104d) which are for providing a durable and aesthetically pleasing exterior surface for window assembly 10. As shown in FIGS. 1-X, exterior cladding members 104a-104d define a frame in the shape of a rectangle or square. Other shapes are possible. Each of the exterior cladding members 104a-104d may be cut from exterior cladding stock such that they all have the same cross-sectional profile. Further, exterior cladding stock can be produced in lineal fashion such that many exterior cladding members can be cut from a single length of stock. Thus, the use of a single lineal profile for cladding members 104a-104d results in a reduction of frame part types, part machining, and assembly time. In the exemplary embodiment shown, each of the exterior cladding members 104a-104d is a painted aluminum extrusion, but may be constructed from other extrudeable, pultrudeable or roll formed materials as well, including but not limited to steel alloys, polyolefin polymers, cellular PVC (polyvinyl chloride or vinyl) polymers, cellulosic plastic composites, fiberglass composites, polymeric alloys or other extrudeable, pultrudeable and formable material. The cladding members 104a0-104d may be attached to the base frame members 102a-102d in a variety of ways, for example with fasteners, adhesives, and/or snap-fit type connections.

The base frame assembly 100 may also include additional trim pieces, for example jamb extenders 176a, 176b, 176c, 176d (176a-176d) and interior trim components 174a, 174b, 174c, 174d (174a-174d). Jamb extenders 176a-176d function to extend the width of the base frame assembly 100 as necessary to ensure that the base frame members 102a-102d and the jamb extenders 176a-176d extend the entire width of the rough opening for the window. The trim components 174a-174d can be provided in the form of head stops and sill stops.

Another aspect of window assembly 10 is sash assembly 150. Sash assembly 150 is for securing a window pane 150 and for providing a moveable assembly such that the window assembly 10 can be opened to the outdoors, where desired. In the exemplary embodiment shown, sash assembly 150 includes a plurality of first sash frame members 152a, 152b, 152c, 152d (152a-152d) and a plurality of sash cladding members 154a, 154b, 154c, 154d (154a-154d) attached to the sash frame members 152a-152d. In one embodiment, the sash cladding members 154a-154d are attached to the sash frame members 152a-152d by a snap-fit type connection, although other fastening means may be used. A plurality of second sash frame members 172a, 172b, 172c, 172d (172a-172d) can also be provided that, in cooperation with the sash cladding members 154a-154d, retain the glass pane 170 within the sash assembly 150. The second sash frame members 172a-172d can be a separate component or an integral component of first sash frame members 152a-152d. In one embodiment, the first sash frame members 152a-152d and the second sash frame members 172a-172d are made from a wood-type material and the sash cladding members 154a-154d are made from a plastic or metal type material.

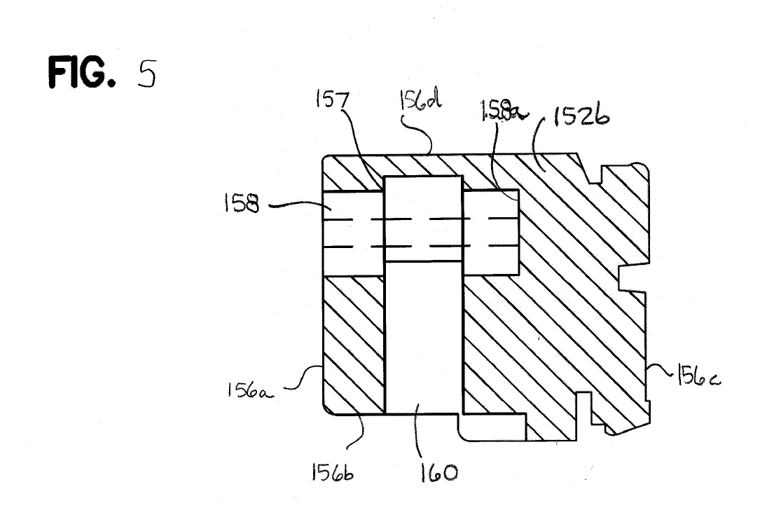

In order to accommodate the lock assembly 200 (discussed later), one of the first sash frame members 152a-152d, for example sash frame member 152b, may be provided with a passageway 157 cooperatively defined by a bore 158 and an intersecting channel 160 that is generally orthogonal to the bore 158. The passageway 157 is configured to allow various components of the lock assembly 200 to pass through the sash frame member 152a and extend towards the base frame member 102b. Referring to FIG. 5, the bore 158 extends from a first side 156a of the frame member 152b towards a third side 156c of the frame member 152b, while the channel 160 extends from a second side 156b of the frame member 152b towards a fourth side 156d of the frame member 152b. In the exemplary embodiment shown, the bore 158 is generally cylindrical in shape while the channel 160 is in the general form of a notched rectangular prism. In one embodiment, the bore 158 is about one inch deep with a diameter of about 0.4 inches while the channel 160 has a depth of about 1.2 inches, and a width, at the un-notched portion, of about 1.5 inches, and a height of about 0.4 inches. However, one skilled in the art will appreciate that other dimensions are possible without departing from the concepts presented herein.

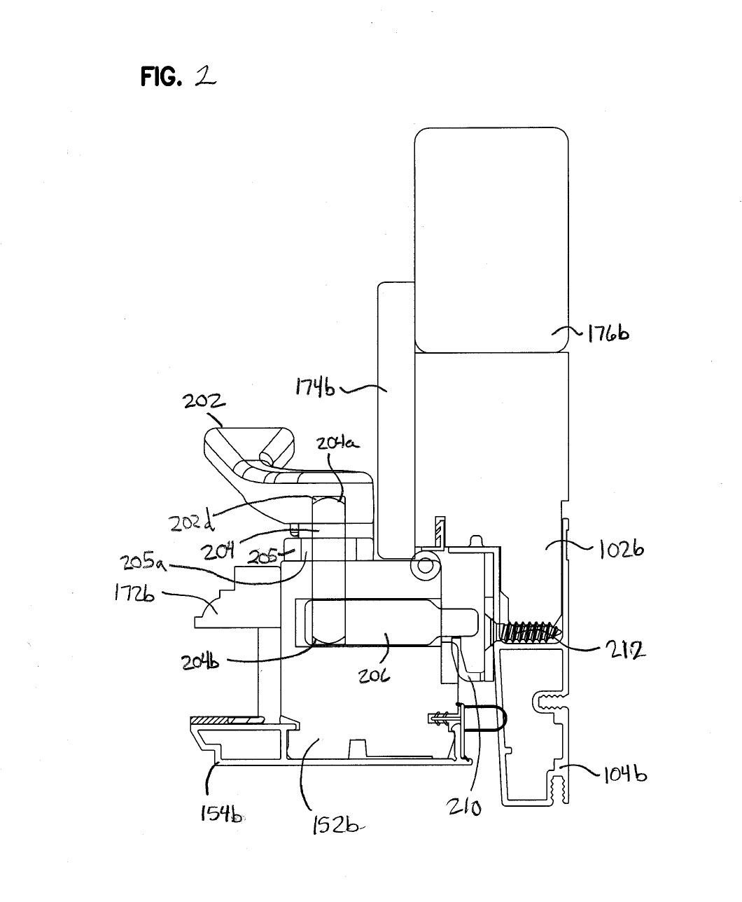

The lock assembly 200 and related components are shown in greater detail in FIGS. 2 and 6-15. The lock assembly 200 is for providing a mechanism that will allow the sash assembly 150 to be selectively retained in a closed, locked position. In the exemplary embodiment shown, the lock assembly 200 may include a lock handle 202, a lock pin 204, a mounting plate 205 a lock pawl 206, and a lock keeper 210, each of which is discussed in further detail below. The components of the lock assembly 200 may be made of a metal material, a plastic material and/or a combination of plastic and metal materials.

As presented, the lock handle 202 includes a first end 202a and a second end 202b. Between the first and second ends 202a, 202b is a handle portion 202c that is shaped to allow a user's hand to grasp and rotate the lock handle 202. Near the second end 202b, the lock handle 202 is provided with a cavity 202d for receiving a first end 204a of the lock pin 204. In one embodiment, the cavity 202d f the lock handle 202 and the first end 204a of the lock pin 204 are provided with complementary splines to prevent the handle 202 and lock pin 204 from rotating relative to one another and ensure that any rotation of the handle 202 causes a corresponding rotation of the lock pin 204. It is noted that although the lock handle 202 and the lock pin 204 are shown as being separate components, they can be integrally formed as a single unit as well.

In one embodiment, the mounting plate 205 is mounted to the first side 156a of the sash member 152b and has a central aperture 205a aligned with the bore 158 of the passageway 157. The mounting plate 205 can be mounted to the sash member by fasteners 205c that extend through mounting holes 205b in the plate 205. As configured, the lock pin 204 extends through the central aperture 205a of the mounting plate 205, through the bore 158, and into the channel 160.

As shown, the lock pawl 206 has a first end 206a and a second end 206b, and is non-rotatably connected to the lock pin 204 such that rotation by the lock handle 202 imparts a rotation to the lock pawl 206 which occurs within and beyond channel 160. As the lock pawl 206 and the lock handle 202 are generally parallel when connected to the lock pin 204, the pawl 206 and handle 202 operate in generally parallel planes of rotation. To secure the lock pin 204 to the lock pawl 206, the lock pawl 206 can be provided with an aperture 206c that engages with the second end 204b of the lock pin 204. As shown, the lock pawl aperture 206c is generally rectangular in shape, as is the second end 204b of the lock pin 204. However, it is noted that the lock pin second end 204b and the lock pawl aperture 206c could be configured in any manner that effectively creates a non-rotatable connection such as a splined connection.

The lock pawl 206 is also shown as being provided with a narrowed portion 206d at the second end 206 which is configured to enhance engagement with a latch portion 210b of the lock keeper 210. In one aspect, the advantage to the narrowing of the pawl 206 at the end is to allow proper engagement with lock keeper within the limited thickness of the sash stile. As shown, the lock keeper 210 also includes a base portion 210a with mounting holes 210c for securing the base portion 210a to the cladding member 104b opposite the sash frame member 152b. As presented, the shorter latch portion 210b is spaced from and parallel to the longer base portion 210a such that the lock keeper 210 forms a J-shape. In one embodiment, fasteners 212, such as wood screws, secure the lock keeper 210 to the cladding member 104b. By mounting the lock keeper 210 to the cladding member 104b, fabrication can be simplified and costs can be reduced.

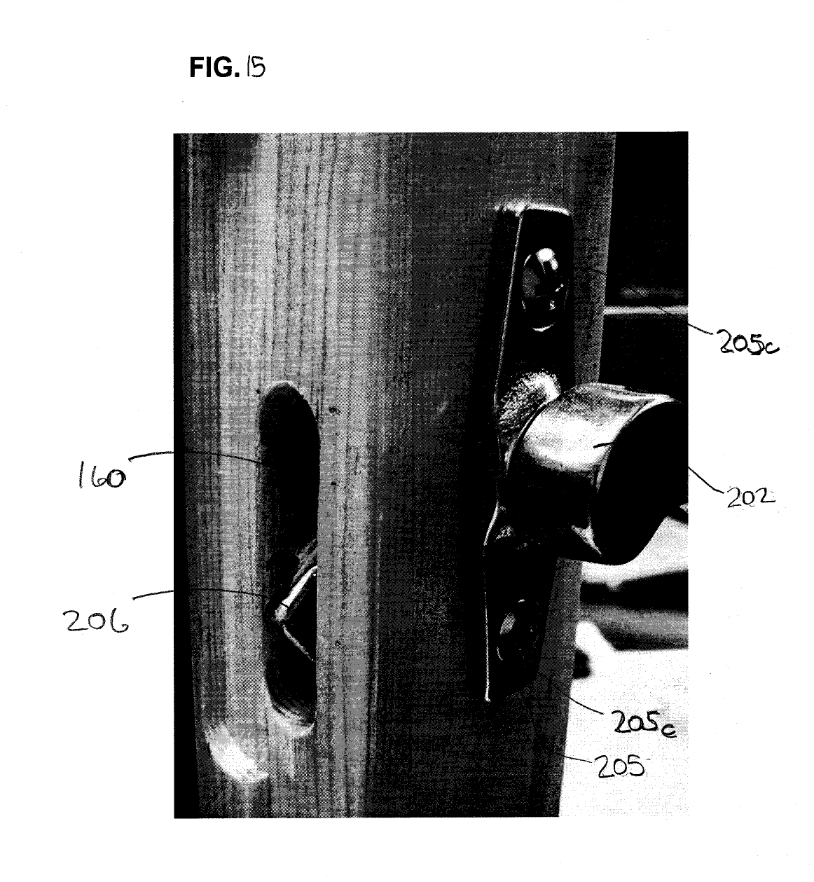

In operation, the lock assembly 200 can be placed in a locked position or an unlocked position by operation of the lock handle 202. In the locked position, the lock pawl 206 is rotated by the lock handle 202 and lock pin 204 such that the lock pawl second end 206b rotates beyond the sash member second side 156b and engages with the latch portion 210b of the lock keeper 210. Once engaged, the sash assembly 150 is prevented from being able to rotate with respect to the cladding member 104b and out of the closed position. In the unlocked position, the lock pawl 206 is rotated by the lock handle 202 and lock pin 204 such that the lock pawl second end 206b disengages with the latch portion 210b of the lock keeper 210, and fully within channel 160, to allow the sash assembly 150 to rotate out of the closed position and towards the open position. For the purpose of illustration, FIG. 14 is provided to show the lock handle 202 and lock pawl 206 rotated into the locked position, but with the sash 152 in the open position so that the components can be easily viewed. FIG. 15 shows the lock handle 202 and lock pawl 206 in the unlocked position with the sash 152 in the open position wherein the lock pawl 206 is fully housed within the channel 160.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

What is claimed is:

1. A window assembly comprising:
(a) a base frame assembly including a plurality of base frame members and a plurality of frame cladding members connected to the base frame members;
(b) a sash assembly including a plurality of sash frame members, the sash assembly being rotatably mounted to the base frame assembly and movable between an open position and a closed position;
(c) a lock assembly including a lock keeper and a lock handle non-rotatably connected to a lock pawl, the lock keeper being mounted to one of the cladding frame members, the lock handle being operably mounted to one of the sash frame members such that the lock pawl is at least partially disposed within the sash frame member;
(d) the lock handle and lock pawl being rotatable from a locked position to an unlocked position wherein;
i. in the locked position, the lock pawl is rotated by the lock handle such that the lock pawl engages with the lock keeper to prevent the sash assembly from being able to rotate out of the closed position;
ii. in the unlocked position, the lock pawl is rotated by the lock handle such that the lock pawl second end 206b disengages with the latch portion 210b of the lock keeper 210 to allow the sash assembly to rotate out of the closed position and towards the open position.

2. The window assembly of claim 1, wherein the lock handle is connected to the lock pawl by a lock pin.

3. The window assembly of claim 2, wherein the sash member to which the lock assembly is mounted includes a passageway for receiving the lock pin and the lock pawl.

4. The window assembly of claim 3, wherein the passageway includes a bore and an intersecting orthogonal channel and wherein the lock pin extends through the bore and into the channel and the lock pawl is disposed within the channel.

5. The window assembly of claim 1, wherein the cladding member is formed from a metal material.

6. The window assembly of claim 2, wherein the lock pin and the lock handle are engaged to each other with a splined connection.

7. The window assembly of claim 4, wherein the lock pawl is fully within the channel when the lock handle is fully rotated in the unlocked position and extends beyond the channel when the lock handle is fully rotated in the locked position.

8. The window assembly of claim 1, wherein the lock pawl and the lock keeper are formed from a metal material.

9. A window assembly comprising:
(a) a base frame assembly including a plurality of base frame members and a plurality of base frame cladding members connected to the base frame members;
(b) a sash assembly retaining a glass pane and being rotatably mounted to the base frame assembly and movable between an open position and a closed position;
i. the sash assembly including a plurality of sash members and a plurality of sash cladding members attached to the sash members, each of the sash members having a first side, a second side, a third side, and a fourth side;
ii. wherein at least one of the sash members has a bore extending from the sash member first side to a bore end, and has a slot extending from the sash member second side to a slot end, the bore meeting the slot near the bore end and the slot end;
(c) a lock assembly including:
i. a lock keeper having a base portion and a latch portion, the base portion being mounted to one of the base frame cladding members;
ii. a lock handle;
iii. a lock pin having a first end and a second end, the lock pin extending through the bore and being non-rotatably attached at the first end to the lock handle;
iv. a lock pawl having a first end and a second end, the lock pawl extending within the slot, the lock pawl first end being non-rotatably attached to the lock pin second end;
1. the lock pawl being rotatable from a locked position to an unlocked position wherein;
a. in the locked position, the lock pawl is rotated by the lock handle and lock pin such that the lock pawl second end engages with the latch portion of the lock keeper to prevent the sash assembly from being able to rotate out of the closed position;
b. in the unlocked position, the lock pawl is rotated by the lock handle and lock pin such that the lock pawl second end disengages with the latch portion of the lock keeper to allow the sash assembly to rotate out of the closed position and towards the open position.
